(19) United States
(12) Patent Application Publication
(10) Pub. No.: US 2025/0050500 A1
(43) Pub. Date: Feb. 13, 2025

(54) ASSEMBLING PRODUCTS IN AN ASSEMBLY PLANT USING MOBILE ASSEMBLING UNITS

(71) Applicant: International Business Machines Corporation, Armonk, NY (US)

(72) Inventors: Sarbajit K. Rakshit, Kolkata (IN); Sudheesh S. Kairali, Kerala (IN); Binoy Thomas, Kerala (IN)

(21) Appl. No.: 18/231,189

(22) Filed: Aug. 7, 2023

(51) Int. Cl. B25J 9/16

(52) U.S. Cl. CPC B25J 9/1664; B25J 9/162; B25J 9/1682; B25J 9/1687

(57) ABSTRACT

Described are techniques for assembling products using mobile assembling units. An assembling sequence to assemble products using the mobile assembling units is generated, where an assembling sequence refers to the order of operations performed by the mobile assembling units, including the paths traveled in the assembly plant to selectively pick designated parts from designated part chambers of an array of part chambers, which forms the assembling floor of the assembly plant. Furthermore, such an assembling sequence specifies not only the path to obtain such parts, but also specifies the specific parts to be picked from the specified part chamber, the assembling of such parts, including which mobile assembling units are to perform such assembling, etc. Additionally, the mobile assembling units are programmed to move over the array of part chambers in a particular path to selectively pick designated parts from designated part chambers based on the assembling sequence.

### TECHNICAL FIELD

The present disclosure relates generally to assembly plants, and more particularly to assembling products in an assembly plant using mobile assembling units.

### BACKGROUND

An assembly plant is a factory where manufactured parts are assembled into a finished product, such as by using an assembly line. An assembly line is a manufacturing process in which parts (usually interchangeable parts) are added as the semi-finished assembly moves from workstation to workstation where the parts are added in sequence until the final assembly is produced. By mechanically moving the parts to the assembly workstation and moving the semi-finished assembly from workstation to workstation, a finished product can be assembled faster and with less labor than by having workers carry parts to a stationary piece for assembly.

### SUMMARY

In one embodiment of the present disclosure, a computer-implemented method for assembling products using mobile assembling units comprises generating an assembling sequence to assemble one or more products using the mobile assembling units, where the assembling sequence comprises an order of operations performed by the mobile assembling units to pick designated parts from designated part chambers in an array of part chambers, and where the array of part chambers forms an assembling floor. The method further comprises programming the mobile assembling units to move over the array of part chambers in a particular path to selectively pick the designated parts from the designated part chambers of the array of part chambers based on the assembling sequence.

Other forms of the embodiments of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates an embodiment of the present disclosure of a communication system for practicing the principles of the present disclosure;

FIG. 2 illustrates the primary physical and logical components of the mobile assembling unit in accordance with an embodiment of the present invention;

FIG. 3 is a diagram of the software components used by the assembling system for assembling different products or the same product with different specifications in a more effective manner using the mobile assembling units in accordance with an embodiment of the present disclosure;

FIG. 4 illustrates an array of the part chambers that forms the assembling floor of the assembly plant in accordance with an embodiment of the present disclosure;

FIG. 5 illustrates a mobile assembling unit utilizing robotic arms for picking parts from part chambers in accordance with an embodiment of the present disclosure;

FIG. 6 illustrates different mobile assembling units moving over the array of part chambers that are selectively picking parts and/or assembling in accordance with an embodiment of the present disclosure;

FIG. 7 illustrates an embodiment of the present disclosure of the hardware configuration of the assembling system which is representative of a hardware environment for practicing the present disclosure;

FIG. 8 is a flowchart of a method for effectively assembling different products or the same product with different specification in an assembly plant in accordance with an embodiment of the present disclosure; and

FIG. 9 is a flowchart of a method for refilling part chambers with additional units of a designated part in accordance with an embodiment of the present disclosure.

### DETAILED DESCRIPTION

As stated above, an assembly plant is a factory where manufactured parts are assembled into a finished product, such as by using an assembly line. An assembly line is a manufacturing process in which parts (usually interchangeable parts) are added as the semi-finished assembly moves from workstation to workstation where the parts are added in sequence until the final assembly is produced. By mechanically moving the parts to the assembly workstation and moving the semi-finished assembly from workstation to workstation, a finished product can be assembled faster and with less labor than by having workers carry parts to a stationary piece for assembly.

Assembly lines are common methods of assembling complex items, such as automobiles and other transportation equipment, household appliances, and electronic goods.

Assembly lines are designed for the sequential organization of workers, tools or machines, and parts. The motion of workers is minimized to the extent possible. All parts or assemblies are handled either by conveyors or motorized vehicles, such as forklifts, or gravity, with no manual trucking. Heavy lifting is done by machines, such as overhead cranes or forklifts. Each worker typically performs one simple operation unless job rotation strategies are applied.

Robotic systems, referred to as assembly line robots, may also be used to assemble parts, including small intricate parts, on the assembly line. Assembly line robot processes provide the speed and precision manufacturers require without sacrificing quality and accuracy. The flexibility of assembly line robots allows manufacturers to optimize workflow and increase capacity.

Currently, assembly lines in assembly plants are used for individual product assembling. For example, a single type of product is assembled on the assembly line of the assembly plant, such as by using assembly line robots.

Unfortunately, such an assembly process does not allow the assembling of different products on the assembly line of the assembly plant. For example, different products are not able to be assembled on the same assembly line of the assembly plant by the assembly line robots. Furthermore, such an assembly process does not allow the assembling of a product with various customizations. For example, a product with different specifications is not able to be assembled on the same assembly line of the assembly plant by the assembly line robots.

As a result, there is not currently an effective means for assembling different products or the same product with different specifications in an assembly plant.

The embodiments of the present disclosure provide a means for effectively assembling different products or the same product with different specification in an assembly plant by programming mobile assembling units (e.g., automated guided vehicles) to move over an array of part chambers, which forms the assembling floor, in a particular path to selectively pick designated parts from designated part chambers based on an assembling sequence. Upon selectively picking the designated parts, one or more mobile assembling units are programmed to assemble two or more parts forming a final product or a component of a final product using the selectively picked designated parts. For situations in which a component of the final product is assembled, the component of the final product may be provided to a different mobile assembling unit to utilize the component of the final product in assembling the final product. In this manner, different products or the same product with different specifications may be effectively assembled in an assembly plant. A further discussion regarding these and other features is provided below.

In some embodiments of the present disclosure, the present disclosure comprises a computer-implemented method, system, and computer program product for assembling products using mobile assembling units. In one embodiment of the present disclosure, an assembling sequence to assemble one or more products using the mobile assembling units is generated. An “assembling sequence,” as used herein, refers to the order of operations performed by the mobile assembling units, including the paths traveled in the assembly plant to selectively pick designated parts (e.g., brake pads, brake rotors, brake shoes, wheel cylinders, wheel bearings, wheel studs, etc.) from designated part chambers of an array of part chambers. In one embodiment, such an assembling sequence specifies not only the path to obtain such parts, but also specifies the specific parts to be picked from the specified part chamber, the assembling of such parts, including which mobile assembling units are to perform such assembling, etc. Furthermore, in one embodiment, the array of part chambers forms the assembling floor of the assembly plant. Additionally, the mobile assembling units are programmed to move over the array of part chambers in a particular path to selectively pick designated parts from designated part chambers based on the assembling sequence. In this manner, different products or the same product with different specifications may be effectively assembled in an assembly plant using mobile assembling units.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

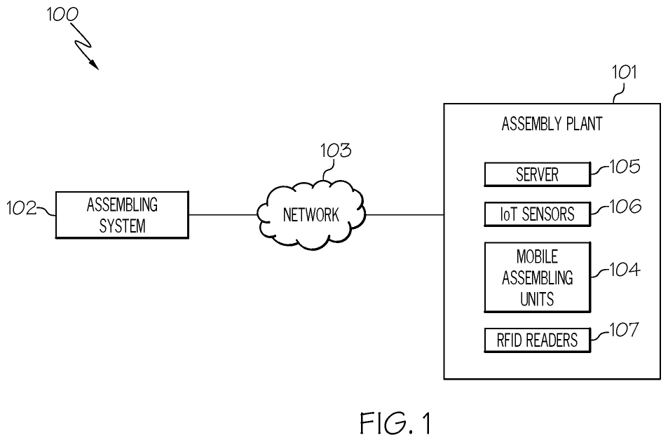

Referring now to the Figures in detail, FIG. 1 illustrates an embodiment of the present disclosure of a communication system 100 for practicing the principles of the present disclosure. Communication system 100 includes an assembly plant 101 connected to an assembling system 102 via a network 103.

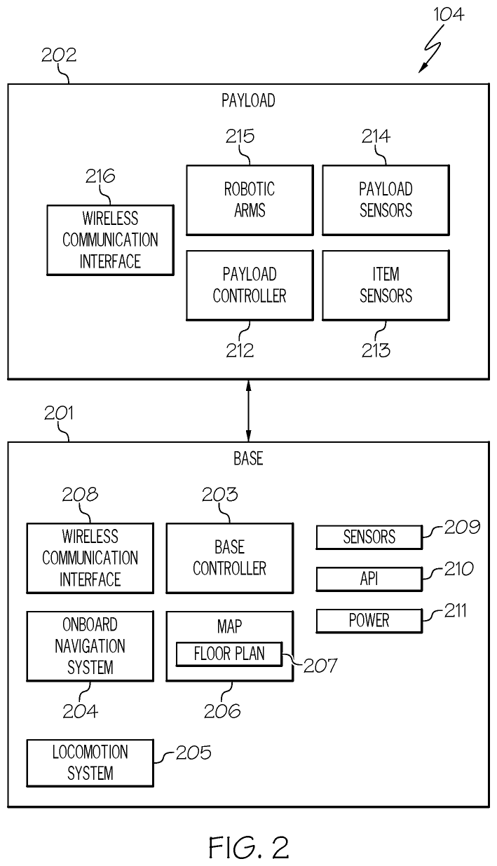

An “assembly plant” 101, as used herein, refers to a complex (e.g., manufacturing plant) which may consist of one or more buildings that include one or more mobile assembling units 104 located on the assembling floor of assembly plant 101. A “mobile assembling unit” 104, as used herein, refers to a portable robot that moves along the assembling floor to pick designated parts from part chambers and assemble said parts into a final product or a component of the final product. Such a mobile assembling unit 104 may use radio waves, vision cameras, magnets, or lasers for navigation. Examples of mobile assembling units 104 include automated guided vehicles (AGVs), autonomous mobile robots, etc. A detailed description of the physical and logical components of mobile assembling units 104 is provided below in connection with FIG. 2.

In one embodiment, mobile assembling units 104 are used to manufacture and produce parts, goods, pieces, etc. in assembly plant 101. For example, such machines may correspond to AGV robots that weld and assemble parts.

In one embodiment, each mobile assembling unit 104 is uniquely identified via a serial number which is stored in a data structure (e.g., table) residing in a storage device of server 105 (discussed further below). In one embodiment, such a data structure is populated by an expert.

In the illustration of FIG. 1, the interconnection of assembly plant 101 to assembling system 102 via network 103 is accomplished via server 105.

In one embodiment, server 105 controls the operations of mobile assembling units 104, such as via automation software. “Automation software,” as used herein, refers to applications that minimize the need for human input and are designed to turn repeatable, routine tasks into automated actions. For example, server 105 utilizes automation software for controlling the operations of mobile assembling units 104, such as loading and unloading parts, material handling, transferring finished parts to post-processing, drilling, welding, painting, product inspection, picking and placing, die casting, glass making, grinding, etc.

In one embodiment, the data regarding the operations being performed by mobile assembling units 104 is obtained from Internet of Things (IoT) sensors 106. IoT sensor 106, as used herein, refers to a sensor that can be attached to mobile assembling unit 104. Furthermore, IoT sensors 106 are configured to exchange data with other devices and systems over a network, such as network 103. In one embodiment, IoT sensors 106 are configured to monitor mobile assembling units 104 in assembly plant 101. For example, IoT sensors 106 may monitor the operations of mobile assembling units 104, such as loading and unloading parts, material handling, transferring finished parts to post-processing, drilling, welding, painting, product inspection, picking and placing, die casting, glass making, grinding, etc. Such data may then be captured by IoT sensors 106 and relayed to server 105 to be stored, such as in a storage device of server 105. Examples of IoT sensors 106 can include, but are not limited to, IoT sensors manufactured by CorSense®, Memfault, Augury®, PTC®, TE Connectivity®, etc.

In one embodiment, the current locations of mobile assembling units 104 in assembly plant 101 are determined based on location information (e.g., GPS (Global Positioning System) data) being provided to sensor 105 via the attached IoT sensors 106.

In one embodiment, assembling system 102 programs mobile assembling units 104 (e.g., automated guided vehicles) either directly or indirectly (via server 105) to move over an array of part chambers, which forms the assembling floor, in a particular path to selectively pick designated parts from designated part chambers based on an assembling sequence, which includes guidance to the location of the designated part chambers. In this manner, different products or the same product with different specifications may be effectively assembled in assembly plant 101.

In one embodiment, such programming of mobile assembling units 104 is based on the assembling sequence generated by assembling system 102, which includes guidance to the location of the designated part chambers. An “assembling sequence,” as used herein, refers to the order of operations performed by mobile assembling units 104, including the paths traveled in assembly plant 101 to selectively pick designated parts (e.g., brake pads, brake rotors, brake shoes, wheel cylinders, wheel bearings, wheel studs, etc.) from designated part chambers of an array of part chambers. In one embodiment, such an assembling sequence specifies not only the path to obtain such parts (guidance to the location of the designated part chambers), but also specifies the specific parts to be picked from specified part chambers, the assembling of such parts, including which mobile assembling units 104 are to perform such assembling, etc. In one embodiment, such part chambers in combination form an array of part chambers, which form the assembling floor of assembly plant 101.

In one embodiment, each part chamber in the array of part chambers is designated to store one or more designated parts, where each part chamber in the array of part chambers is allocated to store a designated number of the designated part(s). In one embodiment, such information pertaining to the part chambers, including the designated part(s) to be stored in such part chambers as well as the quantity of such parts, may be stored in a data structure (e.g., table) that resides within a storage device of assembling system 102. In one embodiment, such a data structure is populated by an expert.

In one embodiment, assembling system 102 is configured to generate the assembling sequence discussed above in a manner that optimizes the movement, including collaborative movement, of mobile assembling units 104 in such a manner as to most efficiently assemble the picked parts. In one embodiment, such an assembling sequence is generated based on identifying the types of products to be assembled and the number of products with different specifications to be assembled. For example, there may be many types of products to be assembled in assembly plant 101 using the parts picked by mobile assembling units 104 in the part chambers, such as the parts used in assembling different types of electronic equipment, ranging from phones to household appliances. In another example, a product may be assembled in a customized manner based on its unique specification. A “specification,” as used herein, refers to a blueprint that outlines the product being assembled, such as the product requirements and functions. For example, a bike may be customized based on its unique specification, such as a specified color (e.g., red), specified frame design, etc. Based on the identified types of products to be assembled and the number of products with different specifications to be assembled, an assembling sequence may be generated by assembling system 102 as discussed in further detail below.

Furthermore, in one embodiment, assembling system 102 generates such an assembling sequence based on how the part chambers are to be filled. In one embodiment, assembling system 102 identifies how the part chambers in the array of part chambers are to be filled based on the identified types of products to be assembled and the number of products with different specifications to be assembled. For example, assembling system 102 ensures that the part chambers contain the parts that are needed by mobile assembling units 104 to assemble the required final product or component of the final product.

In addition to programming mobile assembling units 104 to move over an array of part chambers to selectively pick designated parts from designated part chambers, assembling system 102 is configured to program mobile assembling units 104 either directly or indirectly via server 105 to assemble two or more parts forming a final product or a component of the final product using the selectively picked designated parts. In one embodiment, such programming is based on the assembling sequence which specifies the assembling of the selectively picked parts, including which mobile assembling units 104 are to perform such assembling. In one embodiment, specific mobile assembling units 104 may be tasked with performing different functions, such as performing different types of assembling (e.g., welding, brazing, soldering, riveting, etc.). Based on such assigned tasks, assembling system 102 assigns different mobile assembling units 104 to perform different types of assembling.

Furthermore, in one embodiment, assembling system 102 is configured to instruct a mobile assembling unit(s) 104 either directly or indirectly via server 105 to refill part chambers with additional units of a designated part in response to the part chamber holding a quantity of such a designated part that is less than a threshold value, which may be user-designated. In one embodiment, the current quantity of parts stored in a part chamber, whether for one or more unique parts stored in the part chamber, may be determined based on RFID (radio frequency identification) tags placed on the parts.

In one embodiment, assembly plant 101 includes RFID readers 107 that scan the RFID tags on the parts in the part chambers. In one embodiment, scanning RFID tags includes reading, referencing, and/or obtaining electronically stored information from the RFID tags as would be known by one of ordinary skill in the art in light of the present disclosure. In another embodiment, each RFID tag includes an RF transmitter and receiver. In another embodiment, RFID reader 107 transmits a signal which is received by the RFID tag. The RFID tag responds to the RFID reader 107 with information stored in the RFID tag. Such information may include a location of the part with the attached RFID tag. For example, RFID tags (e.g., Air Finder® active RFID tags and the like) may calculate their location relative to reference points and send this data to nearby RFID readers 107. RFID readers 107 may then send such location data to an application (e.g., Air Finder® & Device Tracker application and the like) of server 105 or assembling system 102 via network 103, which formulates an estimated location of the tagged part. In this manner, the current quantity of the parts stored in a part chamber may be known. In one embodiment, such a current quantity of the parts stored in a part chamber is stored in a storage device of server 105 and relayed to assembling system 102 via network 103 to be stored in a storage device of assembling system 102 or directly stored in the storage device of assembling system 102 after being provided with such information from RFID readers 107.

When the current quantity of the parts stored in the part chamber is below a threshold value, which may be user-designated, assembling system 102 instructs a mobile assembling unit(s) 104 to refill part chambers with additional units of the part. In one embodiment, such threshold values as well as the maximum quantity of a designated part to be stored in a part chamber are stored in a data structure (e.g., table) which resides within the storage device of assembling system 102. In one embodiment, such a data structure is populated by an expert.

In one embodiment, RFID reader 107 is maintained in a low-power state between item scans, extending the battery life of RFID reader 107. In one embodiment, RFID reader 107 may be powered by an onboard battery.

A further discussion regarding these and other features is provided further below.

As discussed above, assembly plant 101 is connected to assembling system 102 via a network 103. Network 103 may be, for example, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

System 100 is not to be limited in scope to any one particular network architecture. System 100 may include any number of assembly plants 101, assembling systems 102, networks 103, mobile assembling units 104, servers 105, IoT sensors 106, and RFID readers 107.

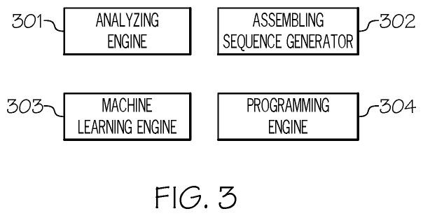

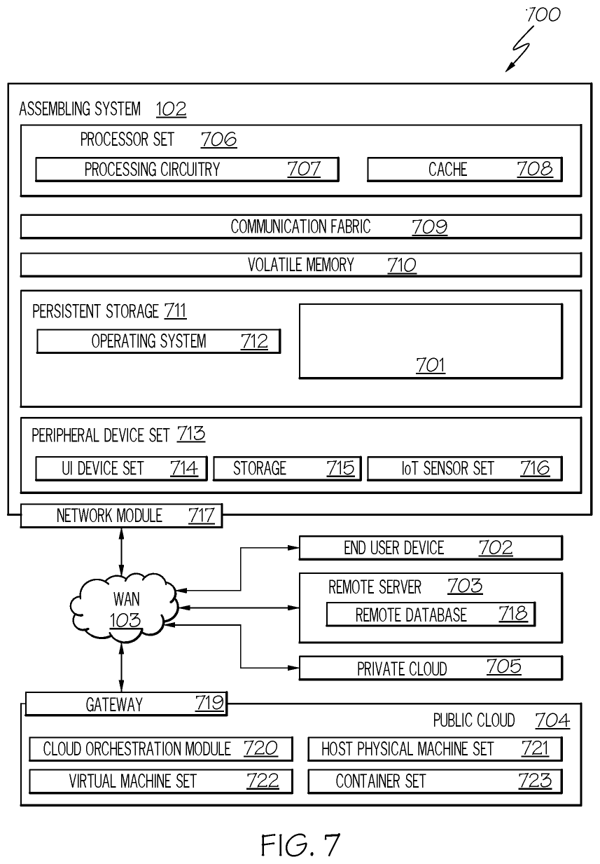

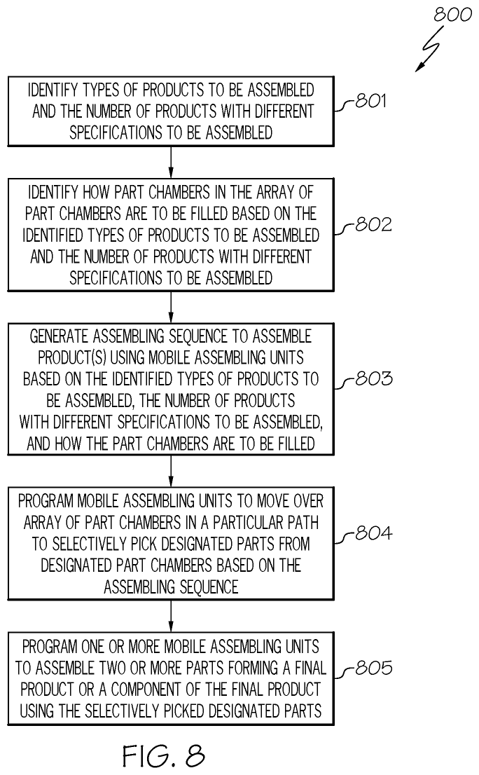

A description of the software components of assembling system 102 used for assembling different products or the same product with different specifications in a more effective manner using mobile assembling units 104 is provided below in connection with FIGS. 3-6. A description of the hardware configuration of assembling system 102 is provided further below in connection with FIG. 7.

Referring now to FIG. 2, FIG. 2 illustrates the primary physical and logical components of mobile assembling unit 104 in accordance with an embodiment of the present invention.

As shown in FIG. 2, mobile assembling unit 104 includes a base 201 and a payload 202. In one embodiment, base 201 includes a variety of hardware and software components, including a base controller 203, an onboard navigation system 204, a locomotion system 205, a map 206 defining a floor plan 207, such as the floor plan of assembly plant 101, a wireless communication interface 208, sensors 209, an application programming interface (API) 210 and a power system 211.

In one embodiment, base controller 203 includes computer program instructions executable on a microprocessor (not shown) to initiate, coordinate, and manage all of the automation functions associated with mobile assembling unit 104, including without limitation, handling of job assignments, automatic locomotion and navigation, communications with other computers and other mobile assembling units 104, activating the payload functions, and controlling power functions. In one embodiment, base controller 203 has an assignment manager (not shown) that keeps track of all of the mobile assembling unit's assignments and job operations. When a job assignment is received by mobile assembling unit 104, base controller 203 activates the other subsystems in mobile assembling unit 104 to respond to the job assignment. Thus, base controller 203 generates and distributes the appropriate command signals that cause other processing modules and units on mobile assembling unit 104 to start carrying out the requested job assignment. So, for example, when the received job assignment requires that mobile assembling unit 104 drive itself to a certain part chamber at a certain location in the physical environment, such as assembly plant 101, it is base controller 203 that generates the command signal that causes onboard navigation system 204 to start driving mobile assembling unit 104 to the specified destination. Base controller 203 also provides an activation signal for payload 202, if necessary, to cause payload 202 to perform a particular operation (e.g., pick designated part from designated part chamber) at the specified job location, which was received from assembling system 102. Base controller 203 also manages and updates map 206, and floor plan 207, when appropriate, based on updated map or floor plan information received from assembling system 102 or other mobile assembling units 104 in the computer network. Base controller 203 also receives assignment status information, if any, from payload 202 and, if appropriate, relays the status information out to assembling system 102, which typically delegates job assignments to mobile assembling units 104. Typically, base controller 203 will communicate with assembling system 102 via an application programming interface (API) 210 and a wireless communications interface 208.

In one embodiment, map 206 defines a floor plan 207 comprised of an array of part chambers corresponding to the physical environment, such as assembly plant 101, and also defines a set of job locations in terms of floor plan 207. In one embodiment, map 206 also associates one or more job operations with one or more of the job locations in the set of job locations. In one embodiment, each job location on floor plan 207 corresponds to an actual location in the physical environment, such as assembly plant 101. Some of the job locations on floor plan 207 will also have associated with them a set of one or more job operations to be carried out automatically by mobile assembling unit 104 after mobile assembling unit 104 arrives at the actual location. In one embodiment, map 206 may be obtained by base controller 203 from assembling system 102 or from another mobile assembling unit 104 or from a standalone operating terminal for the network (not shown). Certain job operations on floor plan 207 may have multiple locations in the physical environment, such as assembly plant 101. It is understood, however, that not all job operations need to be pre-programmed into map 206. It is also possible for job operations to be commanded as needed by base controller 203, or assembling system 102, irrespective of whether or not the job operation is defined in map 206.

In one embodiment, onboard navigation system 204, operating under the control of base controller 203, handles all of the localization, path planning, path following and obstacle avoidance functions for mobile assembling unit 104. If the system includes a positive and negative obstacle avoidance engine to help mobile assembling unit 104 avoid colliding with objects that may be resting on the floor but whose shape is not appropriately identified by the mobile assembling unit's horizontally scanning laser, and to avoid driving into gaps in the floor, this functionality is encompassed by onboard navigation system 204. In one embodiment, onboard navigation system 204 automatically determines the job location for the job assignment based on the map and the job assignment. Using sensors 209, onboard navigation system 204 also detects when driving mobile assembling unit 104 along a selected path (movement path) from the mobile assembling unit's current position to an actual location in the physical environment will cause mobile assembling unit 104 to touch, collide or otherwise come too close to one or more of the stationary or non-stationary obstacles in the physical environment. When onboard navigation system 204 determines that contact with an obstacle might occur, it is able to automatically plan a path around the obstacle and return to the movement path as established by assembling system 102. In one embodiment, onboard navigation system 204 may also use sensing lasers to sample objects in the physical environment, and compare the samples with information in map 206. This process is called “laser localization.” Another known technique, called light localization, involves using a camera to find lights in the ceiling and then comparing the lights found to lights identified on map 206. All of these different techniques may be employed to help onboard navigation system 204 determine its current position relative to the job location.

In one embodiment, onboard navigation system 204 operates in combination with locomotion system 205 to drive mobile assembling unit 104 from its current location to the source or target location along the established movement path.

In one embodiment, API 210 is operatable with base controller 203 and wireless communication interface 208 to provide information and commands to base controller 203 as well as retrieve job assignment status and route information from base controller 203. For example, if payload 202 needs to send information concerning the status of the item being transported, such information may be transmitted from payload controller 212 to base controller 203 via API 210. Base controller 203 will then transmit such information to assembling system 102 through the same API 210. In one embodiment, API 210 is ARCL or ArInterface, an application programming interface distributed by Omron Adept Technologies, Inc. of San Ramon, California.

Sensors 209 may include a collection of different sensors, such as sonar sensors, bumpers, cameras, gas sensors, smoke sensors, motion sensors, etc., and can be used to perform a variety of different functions. These sensors may also be used for traffic mitigation by redirecting mobile assembling unit 104 when other mobile assembling units 104 are detected in the immediate surroundings. Other elements on base 201 include power 211, which typically includes a battery and software to manage the battery.

In one embodiment, locomotion system 205 includes the hardware and electronics necessary for making mobile assembling unit 104 move including, for example, motors, wheels, feedback mechanisms for the motors and wheels, and encoders. In one embodiment, onboard navigation system 204 “drives” mobile assembling unit 104 by sending commands down to the wheels and motors through locomotion system 205. In one embodiment, such movement of mobile assembling unit 104 is on rails formed by adjacent part chambers as discussed further below.

Referring now to the components of payload 202, item sensors 213 provide signals to payload controller 212 and, possibly, directly to base controller 203 by means of API 210, which permit payload controller 212 and/or base controller 203 to make programmatic decisions about whether mobile assembling unit 104 has completed an assignment or is available to acquire more items.

In one embodiment, payload sensors 214 may include, for example, temperature or gas sensors, cameras, RFID readers, environmental sensors, wireless Ethernet sniffing sensors, etc. In one embodiment, payload sensors 214 may be used to provide information about the state of payload 202, the state of the physical environment, the proximity of mobile assembling unit 104 to physical objects, including other mobile assembling units 104, or some combination of all of this information.

In one embodiment, payload 202 includes robotic arms 215 configured to pick parts from part chambers in an array of part chambers forming the assembling floor of assembly plant 101. A “robotic arm 215,” as used herein, is a type of mechanical arm that is programmable with similar functions to a human arm. In one embodiment, robotic arms 215 are programmed via commands received by base controller 203 and/or payload controller 212 via assembling system 102.

In one embodiment, payload 202 may also include a wireless communications interface 216, which sends information to and receives information from other devices or networks, such as from assembling system 102.

In one embodiment, payload controller 212 processes command and operation signals coming into payload 202 and generally controls and coordinates all of the functions performed by payload 202.

A discussion regarding the software components used by assembling system 102 to assemble different products or the same product with different specifications in a more effective manner using mobile assembling units 104 is provided below in connection with FIG. 3.

FIG. 3 is a diagram of the software components used by assembling system 102 for assembling different products or the same product with different specifications in a more effective manner using mobile assembling units 104 in accordance with an embodiment of the present disclosure.

Referring to FIG. 3, in conjunction with FIGS. 1-2, assembling system 102 includes an analyzing engine 301 configured to identify the types of products to be assembled in assembly plant 101 and the number of products with different specifications to be assembled in assembly plant 101.

For example, there may be many types of products to be assembled in assembly plant 101 using the parts picked by mobile assembling units 104 in the part chambers, such as the parts used in assembling different types of electronic equipment, ranging from phones to household appliances. In another example, a product may be assembled in a customized manner based on its unique specification. A “specification,” as used herein, refers to a blueprint that outlines the product being assembled, such as the product requirements and functions. For example, a bike may be customized based on its unique specification, such as a specified color (e.g., red), specified frame design, etc. Based on the identified types of products to be assembled and the number of products with different specifications to be assembled, an assembling sequence may be generated by assembling system 102 as discussed further below.

In one embodiment, information pertaining to the types of products to be assembled and the number of products with different specifications to be assembled is stored in a data structure (e.g., table) residing within a storage device of assembling system 102. In one embodiment, such information is populated by an expert. Such information may then be retrieved by analyzing engine 301 to identify the types of products to be assembled in assembly plant 101 and the number of products with different specifications to be assembled in assembly plant 101.

Furthermore, in one embodiment, analyzing engine 301 is configured to identify how part chambers in an array of part chambers are to be filled based on the identified types of products to be assembled in assembly plant 101 and the number of products with different specifications to be assembled in assembly plant 101.

In one embodiment, information pertaining to the quantity of the identified types of products to be assembled in assembly plant 101 for a duration of time (e.g., 24-hour period), including the number of such products with different specifications, is stored in a data structure (e.g., table) residing within a storage device of assembling system 102. In one embodiment, such information is populated by an expert. Such information may then be retrieved by analyzing engine 301. For example, suppose that 80 scientific calculators and 100 standard calculators are to be assembled in assembly plant 101 during a 24-hour period. Furthermore, such information may include the number of parts (and the types of parts) needed to be assembled in combination in order to manufacture such products in assembly plant 101, including products with different specifications. For example, in order to assemble a single scientific calculator, various parts may need to be picked from the part chambers, such as a case (e.g., acrylonitrile butadiene styrene (ABS) plastic of type A), a screen (a liquid crystal display of type A), a cell battery (e.g., a lithium battery of type A), a circuit board of type A, etc. In order to assemble a single standard calculator as opposed to assemble a single scientific calculator, some of the same parts are used except that a different circuit, circuit board of type B, is used.

Based on such retrieved information, analyzing engine 301 determines the quantity of parts that are required to be used to assemble the different types of products in assembly plant 101, including those products with different specifications. For instance, referring to the above example, in order to assemble 80 scientific calculators and 100 standard calculators during a 24-hour period in assembly plant 101, 180 cases (e.g., acrylonitrile butadiene styrene (ABS) plastic of type A), 180 screens (a liquid crystal display of type A), 180 cell batteries (e.g., a lithium battery of type A), 80 circuit boards of type A and 100 circuit boards of type B are required.

Based on the quantity of parts that are required to be used to assemble the different types of products in assembly plant 101, including those products with different specifications, analyzing engine 301 identifies how part chambers designated to store such parts are to be filled. For example, analyzing engine 301 ensures that each part chamber currently stores a minimum of a percentage (e.g., 20%), which may be user-designated, of the maximum amount of parts capable to be stored in the part chamber. In another example, analyzing engine 301 ensures that each part chamber currently stores a certain percentage, which may be user-designated, of the quantity of parts (for the part that the part chamber is designated to store) that are required to be used to assemble the different types of products in assembly plant 101, including those products with different specifications. As discussed above, the current number of parts stored in a part chamber is determined via the use of RFID tags attached to the parts.

In one embodiment, analyzing engine 301 utilizes various software tools for identifying how the part chambers are to be filled as discussed above, which can include, but are not limited to, Fulcrum®, NetSuite®, MasterControl® MES, Katana Cloud Manufacturing, Arena PLM®, FactoryLogix® MES, etc.

In one embodiment, an array of part chambers forms the assembling floor of assembly plant 101 as shown in FIG. 4.

Referring to FIG. 4, in conjunction with FIGS. 1-2, FIG. 4 illustrates an array 400 of part chambers 401 that forms the assembling floor of assembly plant 101 in accordance with an embodiment of the present disclosure.

As shown in FIG. 4, an array 400 of part chambers 401 forms an assembling floor of assembly plant 101. In one embodiment, each part chamber 401 is designated to store a specified part (e.g., circuit board type A). For example, as shown in FIG. 4, part chamber 402A is designated to store a different part than part chamber 402B. Furthermore, in one embodiment, each part chamber 401 is designated to store a specified number (quantity) of the specified part. In one embodiment, such information, such as the assignment of part chamber 401 to store a specified part and the specified quantity of the specified part, is stored in a data structure (e.g., table) residing in a storage device of assembling system 102.

In one embodiment, as shown in FIG. 4, adjacent part chambers 401 in the array 400 of part chambers 401 form a rail 403 for movement of mobile assembling units 104. In one embodiment, as discussed in further detail below, mobile assembling units 104 are programmed to move over array 400 of part chambers 401 in a particular path 404 to selectively pick designated parts from designated part chambers 401 based on an assembling sequence, which includes guidance to the location of the designated part chambers 401.

In one embodiment, array 400 of part chambers 401 is configured in a three-dimensional manner.

Returning to FIG. 3, in conjunction with FIGS. 1-2 and 4, assembling system 102 includes an assembling sequence generator 302 configured to generate an assembling sequence to assemble one or more products using mobile assembling units 104 based on the identified types of products to be assembled, the number of products with different specifications to be assembled and how the part chambers are to be filled. An “assembling sequence,” as used herein, refers to the order of operations performed by mobile assembling units 104, including the paths traveled in assembly plant 101 to selectively pick designated parts (e.g., brake pads, brake rotors, brake shoes, wheel cylinders, wheel bearings, wheel studs, etc.) from designated part chambers 401 of an array 400 of part chambers 401. In one embodiment, such an assembling sequence specifies not only the path to obtain such parts (guidance to the location of the designated part chambers 401), but also specifies the specific parts to be picked from specified part chambers 401 (e.g., part chamber 402A), the assembling of such parts, including which mobile assembling units 104 are to perform such assembling, etc.

In one embodiment, assembling sequence generator 302 is configured to generate the assembling sequence discussed above in a manner that optimizes the movement, including collaborative movement, of mobile assembling units 104 in such a manner as to most efficiently assemble the picked parts. In one embodiment, such an assembling sequence is generated based on identifying the types of products to be assembled and the number of products with different specifications to be assembled, where such information is obtained from analyzing engine 301. For example, there may be many types of products to be assembled in assembly plant 101 using the parts picked by mobile assembling units 104 from part chambers 401, such as the parts used in assembling different types of electronic equipment, ranging from phones to household appliances. In another example, a product may be assembled in a customized manner based on its unique specification. A “specification,” as used herein, refers to a blueprint that outlines the product being assembled, such as the product requirements and functions. For example, a bike may be customized based on its unique specification, such as a specified color (e.g., red), specified frame design, etc. Based on the identified types of products to be assembled and the number of products with different specifications to be assembled, an assembling sequence may be generated by assembling sequence generator 302.

For example, mobile assembling units 104 may be designated to perform certain tasks, such as performing different types of assembling (e.g., welding, brazing, soldering, riveting, etc.). Based on such assigned tasks, assembling sequence generator 302 assigns different mobile assembling units 104 to pick different designated parts that are assigned to be stored in different part chambers 401 forming part of the assembling sequence.

Furthermore, based on the defined floor plan 207, such as the floor plan of assembly plant 101 consisting of the array 400 of part chambers 401, assembling sequence generator 302 determines the optimal path for mobile assembling units 104 to reach their designated part chambers 401 to pick their designated quantity of a designated part. In one embodiment, the designated part to be picked by mobile assembling units 104 is based on the type of assembling to be performed by mobile assembling unit 104. In one embodiment, such information is stored in a data structure (e.g., table) residing within the storage device of assembling system 102. In one embodiment, such information is populated by an expert. In one embodiment, the designated number (quantity) of the part to be picked from part chamber 401 is determined based on the number of products (e.g., 100 scientific calculators) to be assembled using the picked parts over a duration of time (e.g., twenty-four hour period). In one embodiment, such information is stored in a data structure (e.g., table) residing within the storage device of assembling system 102. In one embodiment, such information is populated by an expert.

After determining the designated part to be picked by mobile assembling units 104, including the quantity of such parts to be picked, assembling sequence generator 302 utilizes a model to generate the assembling sequence containing the order of operations performed by mobile assembling units 104, including the paths traveled in assembly plant 101 to selectively pick designated parts (e.g., brake pads, brake rotors, brake shoes, wheel cylinders, wheel bearings, wheel studs, etc.) from designated part chambers 401 of an array 400 of part chambers 401.

In one embodiment, machine learning engine 303 of assembling system 102 builds and trains a model to determine an assembling sequence containing the order of operations performed by mobile assembling units 104, including the paths traveled in assembly plant 101 to selectively pick designated parts from designated part chambers 401 of an array 400 of part chambers 401 as well as the specific parts to be picked from specified part chambers 401 (e.g., part chamber 402A), and the assembling of such parts, including which mobile assembling units 104 are to perform such assembling.

In one embodiment, the model is trained to predict such an assembling sequence based on a sample data set that includes the identified types of products to be assembled, the number of products with different specifications to be assembled, how part chambers 401 are to be filled, the specific parts assigned to be stored in each part chamber 401, the quantity of such parts in part chambers 401 prior to being picked by mobile assembling units 104, the quantity of each part needed to be used to assemble the final product during a period of time, the tasks assigned to mobile assembling units 104, the current location of mobile assembling units 104 obtained from IoT sensors 106 attached to mobile assembling units 104, etc. Such a sample data set may be stored in a data structure (e.g., table) residing within the storage device of assembling system 102. In one embodiment, such a data structure is populated by an expert.

Furthermore, in one embodiment, the sample data set discussed above is referred to herein as the “training data,” which is used by the machine learning algorithm to make predictions or decisions as to the assembling sequence. The algorithm iteratively makes predictions on the training data as to the assembling sequence until the predictions achieve the desired accuracy as determined by an expert. Examples of such learning algorithms include nearest neighbor, Naïve Bayes, decision trees, linear regression, support vector machines, and neural networks.

After such a model is trained, it may be utilized by assembling sequence generator 302 to generate the assembling sequence containing the order of operations performed by mobile assembling units 104, including the paths traveled in assembly plant 101 to selectively pick designated parts from designated part chambers 401 of an array 400 of part chambers 401 as well as the specific parts to be picked from specified part chambers 401 (e.g., part chamber 402A), and the assembling of such parts, including which mobile assembling units 104 are to perform such assembling. Such an assembling sequence is generated by assembling sequence generator 302 using the trained model based on providing the model with the identified types of products to be assembled, the number of products with different specifications to be assembled, how part chambers 401 are to be filled, the specific parts assigned to be stored in each part chamber 401, the quantity of such parts in part chambers 401 prior to being picked by mobile assembling units 104, the quantity of each part needed to be used to assemble the final product during a period of time, the tasks assigned to mobile assembling units 104, the current location of mobile assembling units 104 obtained from IoT sensors 106 attached to such mobile assembling units 104, etc.

In one embodiment, assembling sequence generator 302 generates the assembling sequence discussed above using various software tools based on the identified types of products to be assembled, the number of products with different specifications to be assembled, how part chambers 401 are to be filled, the specific parts assigned to be stored in each part chamber 401, the quantity of such parts in part chambers 401 prior to being picked by mobile assembling units 104, the quantity of each part needed to be used to assemble the final product during a period of time, the tasks assigned to mobile assembling units 104, the current location of mobile assembling units 104 obtained from IoT sensors 106 attached to such mobile assembling units 104, etc. Examples of such software tools can include, but are not limited to, Fulcrum®, NetSuite®, MasterControl® MES, Katana Cloud Manufacturing, Arena PLM®, FactoryLogix® MES, KUKA®.PickControl, etc.

Additionally, assembling system 102 includes a programming engine 304 configured to program mobile assembling units 104 either directly or indirectly via server 105 to move over array 400 of part chambers 401 in a particular path to selectively pick designated parts from designated part chambers 401 based on the assembling sequence (generated by assembling sequence generator 302).

In one embodiment, such programming is used to instruct base controller 203 to generate the command signal that causes onboard navigation system 204 to start driving mobile assembling unit 104 to the specified destination. In one embodiment, onboard navigation system 204 operates in combination with locomotion system 205 to drive mobile assembling unit 104 from its current location to the source or target location along the established movement path as established in the assembling sequence.

In one embodiment, locomotion system 205 includes the hardware and electronics necessary for making mobile assembling unit 104 move including, for example, motors, wheels, feedback mechanisms for the motors and wheels, and encoders. In one embodiment, onboard navigation system 204 “drives” mobile assembling unit 104 by sending commands down to the wheels and motors through locomotion system 205. In one embodiment, such movement of mobile assembling unit 104 is on rails 403 formed by adjacent part chambers 401.

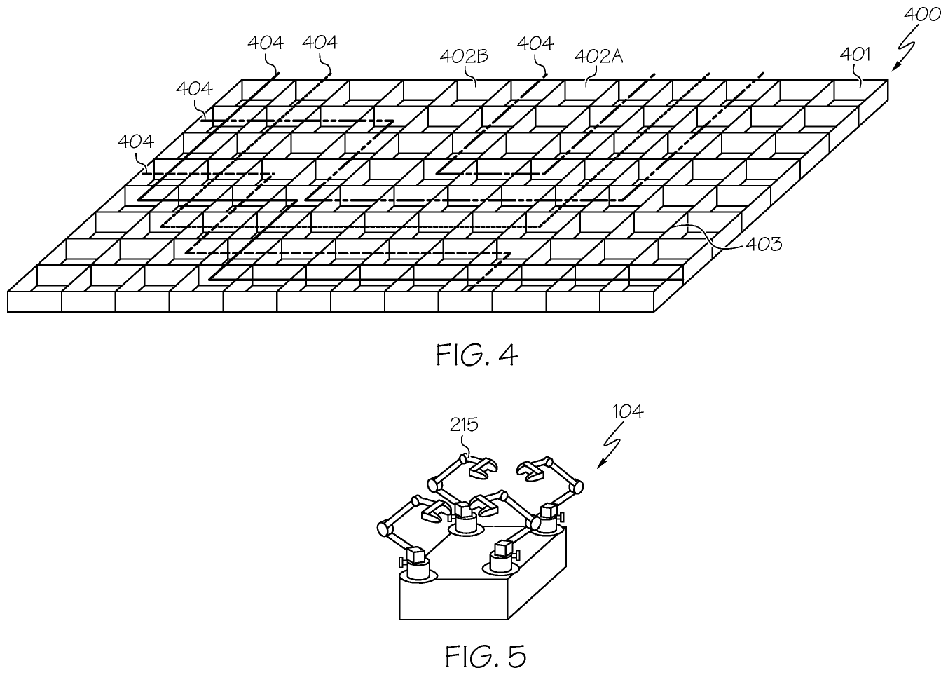

In one embodiment, mobile assembling units 104 utilize robotic arms for picking parts from part chambers 401 as illustrated in FIG. 5.

Referring to FIG. 5, in conjunction with FIGS. 2 and 4, FIG. 5 illustrates mobile assembling unit 104 utilizing robotic arms 215 for picking parts from part chambers 401 in accordance with an embodiment of the present disclosure. While FIG. 5 illustrates mobile assembling unit 104 containing four robotic arms 215, mobile assembling unit 104 may contain any number of robotic arms 215 for picking parts from part chambers 401. Examples of such robotic arms 215 can include, but are not limited to, Jaka® Pro, Kuka® KR Cybertech, Denso® Cobotta Pro, etc.

In one embodiment, the programming to selectively pick designated parts from designated part chambers 401 is used to instruct base controller 203 and/or payload controller 212 to generate the command signal that causes the appropriate movement of robotic arms 215 to pick the designated parts from the designated part chambers 401.

Returning to FIG. 3, in conjunction with FIGS. 1-2 and 4-5, in one embodiment, programming engine 304 programs mobile assembling units 104 either directly or indirectly via server 105 to assemble two or more parts forming a final product or a component of the final product using the selectively picked designated parts. In one embodiment, such programming is based on the assembling sequence which specifies the assembling of the selectively picked parts, including which mobile assembling units 104 are to perform such assembling. In one embodiment, specific mobile assembling units 104 may be tasked with performing different functions, such as performing different types of assembling (e.g., welding, brazing, soldering, riveting, etc.). Based on such assigned tasks, different mobile assembling units 104 are assigned to perform different types of assembling in the assembling sequence.

For situations in which a component of the final product is assembled, the component of the final product may be provided to a different mobile assembling unit 104 to utilize the component of the final product in assembling the final product.

In one embodiment, such programming is used to instruct base controller 203 and/or payload controller 212 to generate the command signals that causes the appropriate movement of robotic arms 215 to assemble two or more parts forming a final product or a component of the final product using the selectively picked designated parts.

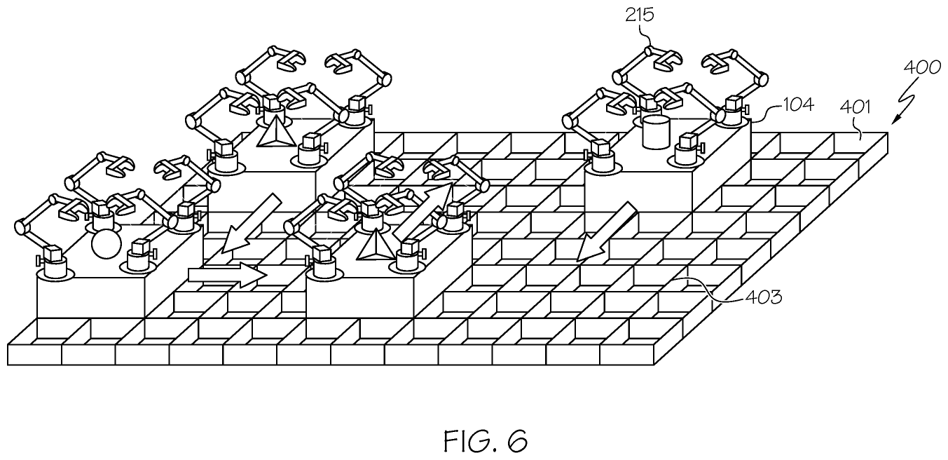

In one embodiment, multiple mobile assembling units 104 may be programmed concurrently to move over array 400 of part chambers 401 in a particular path to selectively pick designated parts from designated part chambers 401 as well as assemble two or more parts forming a final product or a component of the final product using the selectively picked designated parts based on the assembling sequence as illustrated in FIG. 6.

FIG. 6 illustrates different mobile assembling units 104 moving over array 400 of part chambers 401 that are selectively picking parts and/or assembling in accordance with an embodiment of the present disclosure.

As shown in FIG. 6, in conjunction with FIGS. 4-5, various mobile assembling units 104 are moving over array 400 of part chambers 401 selectively picking different parts and performing the assembling of such parts based on the assembling sequence.

Returning to FIG. 3, in conjunction with FIGS. 1-2 and 4-6, in one embodiment, programming engine 304 is configured to instruct a mobile assembling unit(s) 104 either directly or indirectly via server 105 to refill part chambers 401 with additional units of a designated part in response to part chamber 401 holding a quantity of such a designated part that is less than a threshold value, which may be user-designated. In one embodiment, the current quantity of parts stored in part chamber 401, whether for one or more unique parts stored in part chamber 401, may be determined based on RFID (radio frequency identification) tags placed on the parts.

As discussed above, in one embodiment, assembly plant 101 includes an RFID reader 107 that scans the RFID tags on the parts in part chambers 401. In one embodiment, scanning RFID tags includes reading, referencing, and/or obtaining electronically stored information from the RFID tags as would be known by one of ordinary skill in the art in light of the present disclosure. In another embodiment, each RFID tag includes an RF transmitter and receiver. In another embodiment, RFID reader 107 transmits a signal which is received by the RFID tag. The RFID tag responds to the RFID reader 107 with information stored in the RFID tag. Such information may include a location of the part with the attached RFID tag. For example, RFID tags (e.g., Air Finder® active RFID tags and the like) may calculate their location relative to reference points and send this data to nearby RFID readers 107. RFID readers 107 may then send such location data to an application (e.g., Air Finder® & Device Tracker application and the like) of server 105 or assembling system 102 via network 103, which formulates an estimated location of the tagged part. In this manner, the current quantity of the parts stored in part chamber 401 may be known. In one embodiment, such a current quantity of the parts stored in part chamber 401 is stored in a storage device of server 105 and relayed to assembling system 102 via network 103 to be stored in a storage device of assembling system 102 or directly stored in the storage device of assembling system 102 after being provided with such information from RFID readers 107.

When the current quantity of the part stored in part chamber 401 is below a threshold value, which may be user-designated, programming engine 304 instructs a mobile assembling unit(s) 104 to refill part chambers 401 with additional units of the designated part. In one embodiment, such threshold values as well as the maximum quantity of a designated part to be stored in part chamber 401 are stored in a data structure (e.g., table) which resides within the storage device of assembling system 102. In one embodiment, such a data structure is populated by an expert.

In one embodiment, programming engine 304 utilizes various software tools for implementing the programming discussed herein, which can include, but are not limited to, Fulcrum®, NetSuite®, MasterControl® MES, Katana Cloud Manufacturing, Arena PLM®, FactoryLogix® MES, etc.

A further description of these and other features is provided below in connection with the discussion of the method for assembling different products or the same product with different specifications more effectively in assembly plant 101 using mobile assembling units 104.

Prior to the discussion of the method for assembling different products or the same product with different specifications more effectively in assembly plant 101 using mobile assembling units 104, a description of the hardware configuration of assembling system 102 (FIG. 1) is provided below in connection with FIG. 7.

Referring now to FIG. 7, in conjunction with FIG. 1, FIG. 7 illustrates an embodiment of the present disclosure of the hardware configuration of assembling system 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 700 contains an example of an environment for the execution of at least some of the computer code (computer code for assembling different products or the same product with different specifications more effectively in assembly plant 101 using mobile assembling units 104, which is stored in block 701) involved in performing the disclosed methods, such as assembling different products or the same product with different specifications more effectively in assembly plant 101 using mobile assembling units 104. In addition to block 701, computing environment 700 includes, for example, assembling system 102, network 103, such as a wide area network (WAN), end user device (EUD) 702, remote server 703, public cloud 704, and private cloud 705. In this embodiment, assembling system 102 includes processor set 706 (including processing circuitry 707 and cache 708), communication fabric 709, volatile memory 710, persistent storage 711 (including operating system 712 and block 701, as identified above), peripheral device set 713 (including user interface (UI) device set 714, storage 715, and Internet of Things (IoT) sensor set 716), and network module 717. Remote server 703 includes remote database 718. Public cloud 704 includes gateway 719, cloud orchestration module 720, host physical machine set 721, virtual machine set 722, and container set 723.

Assembling system 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 718. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically assembling system 102, to keep the presentation as simple as possible. Assembling system 102 may be located in a cloud, even though it is not shown in a cloud in FIG. 7. On the other hand, assembling system 102 is not required to be in a cloud except to any extent as may be affirmatively indicated.

Processor set 706 includes one, or more, computer processors of any type now known or to be developed in the future. Processing circuitry 707 may be distributed over multiple packages, for example, multiple, coordinated integrated circuit chips. Processing circuitry 707 may implement multiple processor threads and/or multiple processor cores. Cache 708 is memory that is located in the processor chip package(s) and is typically used for data or code that should be available for rapid access by the threads or cores running on processor set 706. Cache memories are typically organized into multiple levels depending upon relative proximity to the processing circuitry. Alternatively, some, or all, of the cache for the processor set may be located “off chip.” In some computing environments, processor set 706 may be designed for working with qubits and performing quantum computing.

Computer readable program instructions are typically loaded onto assembling system 102 to cause a series of operational steps to be performed by processor set 706 of assembling system 102 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 708 and the other storage media discussed below. The program instructions, and associated data, are accessed by processor set 706 to control and direct performance of the disclosed methods. In computing environment 700, at least some of the instructions for performing the disclosed methods may be stored in block 701 in persistent storage 711.

Communication fabric 709 is the signal conduction paths that allow the various components of assembling system 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 710 is any type of volatile memory now known or to be developed in the future. Examples include dynamic type random access memory (RAM) or static type RAM. Typically, the volatile memory is characterized by random access, but this is not required unless affirmatively indicated. In assembling system 102, the volatile memory 710 is located in a single package and is internal to assembling system 102, but, alternatively or additionally, the volatile memory may be distributed over multiple packages and/or located externally with respect to assembling system 102.

Persistent Storage 711 is any form of non-volatile storage for computers that is now known or to be developed in the future. The non-volatility of this storage means that the stored data is maintained regardless of whether power is being supplied to assembling system 102 and/or directly to persistent storage 711. Persistent storage 711 may be a read only memory (ROM), but typically at least a portion of the persistent storage allows writing of data, deletion of data and re-writing of data. Some familiar forms of persistent storage include magnetic disks and solid state storage devices. Operating system 712 may take several forms, such as various known proprietary operating systems or open source Portable Operating System Interface type operating systems that employ a kernel. The code included in block 701 typically includes at least some of the computer code involved in performing the disclosed methods.

Peripheral device set 713 includes the set of peripheral devices of assembling system 102. Data communication connections between the peripheral devices and the other components of assembling system 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 714 may include components such as a display screen, speaker, microphone, wearable devices (such as goggles and smart watches), keyboard, mouse, printer, touchpad, game controllers, and haptic devices. Storage 715 is external storage, such as an external hard drive, or insertable storage, such as an SD card. Storage 715 may be persistent and/or volatile. In some embodiments, storage 715 may take the form of a quantum computing storage device for storing data in the form of qubits. In embodiments where assembling system 102 is required to have a large amount of storage (for example, where assembling system 102 locally stores and manages a large database) then this storage may be provided by peripheral storage devices designed for storing very large amounts of data, such as a storage area network (SAN) that is shared by multiple, geographically distributed computers. IoT sensor set 716 is made up of sensors that can be used in Internet of Things applications. For example, one sensor may be a thermometer and another sensor may be a motion detector.

Network module 717 is the collection of computer software, hardware, and firmware that allows assembling system 102 to communicate with other computers through WAN 103. Network module 717 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 717 are performed on the same physical hardware device. In other embodiments (for example, embodiments that utilize software-defined networking (SDN)), the control functions and the forwarding functions of network module 717 are performed on physically separate devices, such that the control functions manage several different network hardware devices. Computer readable program instructions for performing the disclosed methods can typically be downloaded to assembling system 102 from an external computer or external storage device through a network adapter card or network interface included in network module 717.

WAN 103 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 702 is any computer system that is used and controlled by an end user (for example, a customer of an enterprise that operates assembling system 102), and may take any of the forms discussed above in connection with assembling system 102. EUD 702 typically receives helpful and useful data from the operations of assembling system 102. For example, in a hypothetical case where assembling system 102 is designed to provide a recommendation to an end user, this recommendation would typically be communicated from network module 717 of assembling system 102 through WAN 103 to EUD 702. In this way, EUD 702 can display, or otherwise present, the recommendation to an end user. In some embodiments, EUD 702 may be a client device, such as thin client, heavy client, mainframe computer, desktop computer and so on.

Remote server 703 is any computer system that serves at least some data and/or functionality to assembling system 102. Remote server 703 may be controlled and used by the same entity that operates assembling system 102. Remote server 703 represents the machine(s) that collect and store helpful and useful data for use by other computers, such as assembling system 102. For example, in a hypothetical case where assembling system 102 is designed and programmed to provide a recommendation based on historical data, then this historical data may be provided to assembling system 102 from remote database 718 of remote server 703.

Public cloud 704 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 704 is performed by the computer hardware and/or software of cloud orchestration module 720. The computing resources provided by public cloud 704 are typically implemented by virtual computing environments that run on various computers making up the computers of host physical machine set 721, which is the universe of physical computers in and/or available to public cloud 704. The virtual computing environments (VCEs) typically take the form of virtual machines from virtual machine set 722 and/or containers from container set 723. It is understood that these VCEs may be stored as images and may be transferred among and between the various physical machine hosts, either as images or after instantiation of the VCE. Cloud orchestration module 720 manages the transfer and storage of images, deploys new instantiations of VCEs and manages active instantiations of VCE deployments. Gateway 719 is the collection of computer software, hardware, and firmware that allows public cloud 704 to communicate through WAN 103.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 705 is similar to public cloud 704, except that the computing resources are only available for use by a single enterprise. While private cloud 705 is depicted as being in communication with WAN 103 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 704 and private cloud 705 are both part of a larger hybrid cloud.

Block 701 further includes the software components discussed above in connection with FIGS. 2-6 to assemble different products or the same product with different specifications more effectively in assembly plant 101 using mobile assembling units 104. In one embodiment, such components may be implemented in hardware. The functions discussed above performed by such components are not generic computer functions. As a result, assembling system 102 is a particular machine that is the result of implementing specific, non-generic computer functions.

In one embodiment, the functionality of such software components of assembling system 102, including the functionality for assembling different products or the same product with different specifications more effectively in assembly plant 101 using mobile assembling units 104, may be embodied in an application specific integrated circuit.

As stated above, assembly lines are common methods of assembling complex items, such as automobiles and other transportation equipment, household appliances, and electronic goods. Assembly lines are designed for the sequential organization of workers, tools or machines, and parts. The motion of workers is minimized to the extent possible. All parts or assemblies are handled either by conveyors or motorized vehicles, such as forklifts, or gravity, with no manual trucking. Heavy lifting is done by machines, such as overhead cranes or forklifts. Each worker typically performs one simple operation unless job rotation strategies are applied. Robotic systems, referred to as assembly line robots, may also be used to assemble parts, including small intricate parts, on the assembly line. Assembly line robot processes provide the speed and precision manufacturers require without sacrificing quality and accuracy. The flexibility of assembly line robots allows manufacturers to optimize workflow and increase capacity. Currently, assembly lines in assembly plants are used for individual product assembling. For example, a single type of product is assembled on the assembly line of the assembly plant, such as by using assembly line robots. Unfortunately, such an assembly process does not allow the assembling of different products on the assembly line of the assembly plant. For example, different products are not able to be assembled on the same assembly line of the assembly plant by the assembly line robots. Furthermore, such an assembly process does not allow the assembling of a product with various customizations. For example, a product with different specifications is not able to be assembled on the same assembly line of the assembly plant by the assembly line robots. As a result, there is not currently an effective means for assembling different products or the same product with different specifications in an assembly plant.

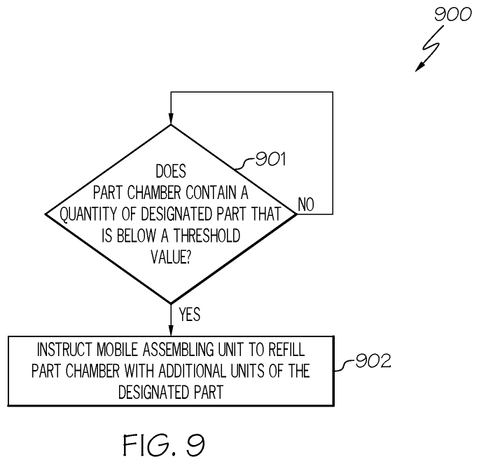

The embodiments of the present disclosure provide a means for effectively assembling different products or the same product with different specification in an assembly plant as discussed below in connection with FIGS. 8-9. FIG. 8 is a flowchart of a method for effectively assembling different products or the same product with different specification in an assembly plant. FIG. 9 is a flowchart of a method for refilling part chambers with additional units of a designated part.

As stated above, FIG. 8 is a flowchart of a method 800 for effectively assembling different products or the same product with different specification in an assembly plant in accordance with an embodiment of the present disclosure.

Referring to FIG. 8, in conjunction with FIGS. 1-7, in operation 801, analyzing engine 301 of assembling system 102 identifies the types of products to be assembled in assembly plant 101 and the number of products with different specifications to be assembled in assembly plant 101.

For example, there may be many types of products to be assembled in assembly plant 101 using the parts picked by mobile assembling units 104 in part chambers 401, such as the parts used in assembling different types of electronic equipment, ranging from phones to household appliances. In another example, a product may be assembled in a customized manner based on its unique specification. A “specification,” as used herein, refers to a blueprint that outlines the product being assembled, such as the product requirements and functions. For example, a bike may be customized based on its unique specification, such as a specified color (e.g., red), specified frame design, etc. Based on the identified types of products to be assembled and the number of products with different specifications to be assembled, an assembling sequence may be generated by assembling sequence generator 302 of assembling system 102 as discussed herein.

As discussed above, in one embodiment, information pertaining to the types of products to be assembled and the number of products with different specifications to be assembled is stored in a data structure (e.g., table) residing within a storage device (e.g., storage device 711, 715) of assembling system 102. In one embodiment, such information is populated by an expert. Such information may then be retrieved by analyzing engine 301 to identify the types of products to be assembled in assembly plant 101 and the number of products with different specifications to be assembled in assembly plant 101.

In operation 802, analyzing engine 301 of assembling system 102 identifies how part chambers 401 in array 400 of part chambers 401 are to be filled based on the identified types of products to be assembled in assembly plant 101 and the number of products with different specifications to be assembled in assembly plant 101.

As stated above, in one embodiment, information pertaining to the quantity of the identified types of products to be assembled in assembly plant 101 for a duration of time (e.g., 24-hour period), including the number of such products with different specifications, is stored in a data structure (e.g., table) residing within a storage device (e.g., storage device 711, 715) of assembling system 102. In one embodiment, such information is populated by an expert. Such information may then be retrieved by analyzing engine 301. For example, suppose that 80 scientific calculators and 100 standard calculators are to be assembled in assembly plant 101 during a 24-hour period. Furthermore, such information may include the number of parts (and the types of parts) needed to be assembled in combination in order to manufacture such products in assembly plant 101, including products with different specifications. For example, in order to assemble a single scientific calculator, various parts may need to be picked from part chambers 401, such as a case (e.g., acrylonitrile butadiene styrene (ABS) plastic of type A), a screen (a liquid crystal display of type A), a cell battery (e.g., a lithium battery of type A), a circuit board of type A, etc. In order to assemble a single standard calculator as opposed to assemble a single scientific calculator, some of the same parts are used except that a different circuit, circuit board of type B, is used.

Based on such retrieved information, analyzing engine 301 determines the quantity of parts that are required to be used to assemble the different types of products in assembly plant 101, including those products with different specifications. For instance, referring to the above example, in order to assemble 80 scientific calculators and 100 standard calculators during a 24-hour period in assembly plant 101, 180 cases (e.g., acrylonitrile butadiene styrene (ABS) plastic of type A), 180 screens (a liquid crystal display of type A), 180 cell batteries (e.g., a lithium battery of type A), 80 circuit boards of type A and 100 circuit boards of type B are required.

Based on the quantity of parts that are required to be used to assemble the different types of products in assembly plant 101, including those products with different specifications, analyzing engine 301 identifies how part chambers 401 designated to store such parts are to be filled. For example, analyzing engine 301 ensures that each part chamber 401 currently stores a minimum of a percentage (e.g., 20%), which may be user-designated, of the maximum amount of parts capable to be stored in part chamber 401. In another example, analyzing engine 301 ensures that each part chamber 401 currently stores a certain percentage, which may be user-designated, of the quantity of parts (for the part that part chamber 401 is designated to store) that are required to be used to assemble the different types of products in assembly plant 101, including those products with different specifications. As discussed above, the current number of parts stored in part chamber 401 is determined via the use of RFID tags attached to the parts.

In one embodiment, analyzing engine 301 utilizes various software tools for identifying how part chambers 401 are to be filled as discussed above, which can include, but are not limited to, Fulcrum®, NetSuite®, MasterControl® MES, Katana Cloud Manufacturing, Arena PLM®, FactoryLogix® MES, etc.

In one embodiment, an array of part chambers forms the assembling floor of assembly plant 101 as shown in FIG. 4.

As shown in FIG. 4, an array 400 of part chambers 401 forms an assembling floor of assembly plant 101. In one embodiment, each part chamber 401 is designated to store a specified part (e.g., circuit board type A). For example, as shown in FIG. 4, part chamber 402A is designated to store a different part than part chamber 402B. Furthermore, in one embodiment, each part chamber 401 is designated to store a specified number (quantity) of the specified part. In one embodiment, such information, such as the assignment of part chamber 401 to store a specified part and the specified quantity of the specified part, is stored in a data structure (e.g., table) residing in a storage device (e.g., storage device 711, 715) of assembling system 102.

In one embodiment, as shown in FIG. 4, adjacent part chambers 401 in the array 400 of part chambers 401 form a rail 403 for movement of mobile assembling units 104. In one embodiment, as discussed in further detail below, mobile assembling units 104 are programmed to move over array 400 of part chambers 401 in a particular path 404 to selectively pick designated parts from designated part chambers 401 based on an assembling sequence.

In one embodiment, array 400 of part chambers 401 is configured in a three-dimensional manner.

Returning to FIG. 8, in conjunction with FIGS. 1-7, in operation 803, assembling sequence generator 302 of assembling system 102 generates an assembling sequence to assemble one or more products using mobile assembling units 104 based on the identified types of products to be assembled, the number of products with different specifications to be assembled and how part chambers 401 are to be filled. An “assembling sequence,” as used herein, refers to the order of operations performed by mobile assembling units 104, including the paths traveled in assembly plant 101 to selectively pick designated parts (e.g., brake pads, brake rotors, brake shoes, wheel cylinders, wheel bearings, wheel studs, etc.) from designated part chambers 401 of an array 400 of part chambers 401. In one embodiment, such an assembling sequence specifies not only the path to obtain such parts (guidance to the location of the designated part chambers 401), but also specifies the specific parts to be picked from specified part chambers 401 (e.g., part chamber 402A), the assembling of such parts, including which mobile assembling units 104 are to perform such assembling, etc.

As discussed above, in one embodiment, assembling sequence generator 302 generates the assembling sequence discussed above in a manner that optimizes the movement, including collaborative movement, of mobile assembling units 104 in such a manner as to most efficiently assemble the picked parts. In one embodiment, such an assembling sequence is generated based on identifying the types of products to be assembled and the number of products with different specifications to be assembled, where such information is obtained from analyzing engine 301. For example, there may be many types of products to be assembled in assembly plant 101 using the parts picked by mobile assembling units 104 from part chambers 401, such as the parts used in assembling different types of electronic equipment, ranging from phones to household appliances. In another example, a product may be assembled in a customized manner based on its unique specification. A “specification,” as used herein, refers to a blueprint that outlines the product being assembled, such as the product requirements and functions. For example, a bike may be customized based on its unique specification, such as a specified color (e.g., red), specified frame design, etc. Based on the identified types of products to be assembled and the number of products with different specifications to be assembled, an assembling sequence may be generated by assembling sequence generator 302.

For example, mobile assembling units 104 may be designated to perform certain tasks, such as performing different types of assembling (e.g., welding, brazing, soldering, riveting, etc.). Based on such assigned tasks, assembling sequence generator 302 assigns different mobile assembling units 104 to pick different designated parts that are assigned to be stored in different part chambers 401 forming part of the assembling sequence.

Furthermore, based on the defined floor plan 207, such as the floor plan of assembly plant 101 consisting of the array 400 of part chambers 401, assembling sequence generator 302 determines the optimal path for mobile assembling units 104 to reach their designated part chambers 401 to pick their designated quantity of a designated part. In one embodiment, the designated part to be picked by mobile assembling units 104 is based on the type of assembling to be performed by mobile assembling unit 104. In one embodiment, such information is stored in a data structure (e.g., table) residing within the storage device (e.g., storage device 711, 715) of assembling system 102. In one embodiment, such information is populated by an expert. In one embodiment, the designated number (quantity) of the part to be picked from part chamber 401 is determined based on the number of products (e.g., 100 scientific calculators) to be assembled using the picked parts over a duration of time (e.g., twenty-four hour period). In one embodiment, such information is stored in a data structure (e.g., table) residing within the storage device (e.g., storage device 711, 715) of assembling system 102. In one embodiment, such information is populated by an expert.

After determining the designated part to be picked by mobile assembling units 104, including the quantity of such parts to be picked, assembling sequence generator 302 utilizes a model to generate the assembling sequence containing the order of operations performed by mobile assembling units 104, including the paths traveled in assembly plant 101 to selectively pick designated parts (e.g., brake pads, brake rotors, brake shoes, wheel cylinders, wheel bearings, wheel studs, etc.) from designated part chambers 401 of an array 400 of part chambers 401.

In one embodiment, machine learning engine 303 of assembling system 102 builds and trains a model to determine an assembling sequence containing the order of operations performed by mobile assembling units 104, including the paths traveled in assembly plant 101 to selectively pick designated parts from designated part chambers 401 of an array 400 of part chambers 401 as well as the specific parts to be picked from specified part chambers 401 (e.g., part chamber 402A), and the assembling of such parts, including which mobile assembling units 104 are to perform such assembling.

In one embodiment, the model is trained to predict such an assembling sequence based on a sample data set that includes the identified types of products to be assembled, the number of products with different specifications to be assembled, how part chambers 401 are to be filled, the specific parts assigned to be stored in each part chamber 401, the quantity of such parts in part chambers 401 prior to being picked by mobile assembling units 104, the quantity of each part needed to be used to assemble the final product during a period of time, the tasks assigned to mobile assembling units 104, the current location of mobile assembling units 104 obtained from IoT sensors 106 attached to mobile assembling units 104, etc. Such a sample data set may be stored in a data structure (e.g., table) residing within the storage device (e.g., storage device 711, 715) of assembling system 102. In one embodiment, such a data structure is populated by an expert.

Furthermore, in one embodiment, the sample data set discussed above is referred to herein as the “training data,” which is used by the machine learning algorithm to make predictions or decisions as to the assembling sequence. The algorithm iteratively makes predictions on the training data as to the assembling sequence until the predictions achieve the desired accuracy as determined by an expert. Examples of such learning algorithms include nearest neighbor, Naïve Bayes, decision trees, linear regression, support vector machines, and neural networks.

After such a model is trained, it may be utilized by assembling sequence generator 302 to generate the assembling sequence containing the order of operations performed by mobile assembling units 104, including the paths traveled in assembly plant 101 to selectively pick designated parts from designated part chambers 401 of an array 400 of part chambers 401 as well as the specific parts to be picked from specified part chambers 401 (e.g., part chamber 402A), and the assembling of such parts, including which mobile assembling units 104 are to perform such assembling. Such an assembling sequence is generated by assembling sequence generator 302 using the trained model based on providing the model with the identified types of products to be assembled, the number of products with different specifications to be assembled, how part chambers 401 are to be filled, the specific parts assigned to be stored in each part chamber 401, the quantity of such parts in part chambers 401 prior to being picked by mobile assembling units 104, the quantity of each part needed to be used to assemble the final product during a period of time, the tasks assigned to mobile assembling units 104, the current location of mobile assembling units 104 obtained from IoT sensors 106 attached to such mobile assembling units 104, etc.

In one embodiment, assembling sequence generator 302 generates the assembling sequence discussed above using various software tools based on the identified types of products to be assembled, the number of products with different specifications to be assembled, how part chambers 401 are to be filled, the specific parts assigned to be stored in each part chamber 401, the quantity of such parts in part chambers 401 prior to being picked by mobile assembling units 104, the quantity of each part needed to be used to assemble the final product during a period of time, the tasks assigned to mobile assembling units 104, the current location of mobile assembling units 104 obtained from IoT sensors 106 attached to such mobile assembling units 104, etc. Examples of such software tools can include, but are not limited to, Fulcrum®, NetSuite®, MasterControl® MES, Katana Cloud Manufacturing, Arena PLM®, FactoryLogix® MES, KUKA®.PickControl, etc.

In operation 804, programming engine 304 of assembling system 102 programs mobile assembling units 104 (directly or indirectly via server 105) to move over array 400 of part chambers 401 in a particular path to selectively pick designated parts from designated part chambers 401 based on the assembling sequence (generated by assembling sequence generator 302).

As stated above, in one embodiment, such programming is used to instruct base controller 203 to generate the command signal that causes onboard navigation system 204 to start driving mobile assembling unit 104 to the specified destination. In one embodiment, onboard navigation system 204 operates in combination with locomotion system 205 to drive mobile assembling unit 104 from its current location to the source or target location along the established movement path as established in the assembling sequence.

In one embodiment, locomotion system 205 includes the hardware and electronics necessary for making mobile assembling unit 104 move including, for example, motors, wheels, feedback mechanisms for the motors and wheels, and encoders. In one embodiment, onboard navigation system 204 “drives” mobile assembling unit 104 by sending commands down to the wheels and motors through locomotion system 205. In one embodiment, such movement of mobile assembling unit 104 is on rails 403 formed by adjacent part chambers 401.

In one embodiment, mobile assembling units 104 utilize robotic arms 215 for picking parts from part chambers 401 as illustrated in FIG. 5.

In one embodiment, the programming to selectively pick designated parts from designated part chambers 401 is used to instruct base controller 203 and/or payload controller 212 to generate the command signal that causes the appropriate movement of robotic arms 215 to pick the designated parts from the designated part chambers 401.

In operation 805, programming engine 304 of assembling system 102 programs (either directly or indirectly via server 105) mobile assembling units 104 to assemble two or more parts forming a final product or a component of the final product using the selectively picked designated parts.

For situations in which a component of the final product is assembled, the component of the final product may be provided to a different mobile assembling unit 104 to utilize the component of the final product in assembling the final product.

As discussed above, in one embodiment, such programming is based on the assembling sequence which specifies the assembling of the selectively picked parts, including which mobile assembling units 104 are to perform such assembling. In one embodiment, specific mobile assembling units 104 may be tasked with performing different functions, such as performing different types of assembling (e.g., welding, brazing, soldering, riveting, etc.). Based on such assigned tasks, different mobile assembling units 104 are assigned to perform different types of assembling in the assembling sequence.

In one embodiment, such programming is used to instruct base controller 203 and/or payload controller 212 to generate the command signals that causes the appropriate movement of robotic arms 215 to assemble two or more parts forming a final product or a component of the final product using the selectively picked designated parts.

In one embodiment, multiple mobile assembling units 104 may be programmed concurrently to move over array 400 of part chambers 401 in a particular path to selectively pick designated parts from designated part chambers 401 as well as assemble two or more parts forming a final product or a component of the final product using the selectively picked designated parts based on the assembling sequence as illustrated in FIG. 6.

As shown in FIG. 6, various mobile assembling units 104 are moving over array 400 of part chambers 401 selectively picking different parts and performing the assembling of such parts based on the assembling sequence.

A discussion regarding refilling part chamber 401, such as when part chamber 401 contains a low volume of a designated part, is discussed below in connection with FIG. 9.

FIG. 9 is a flowchart of a method 900 for refilling part chambers with additional units of a designated part in accordance with an embodiment of the present disclosure.

Referring to FIG. 9, in conjunction with FIGS. 1-8, in operation 901, programming engine 304 of assembling system 102 determines whether a part chamber 401 contains a quantity of a designated part (e.g., circuit board of type A) that is below a threshold value, which may be user-designated.

As stated above, in one embodiment, the current quantity of parts stored in part chamber 401, whether for one or more unique parts stored in part chamber 401, may be determined based on RFID (radio frequency identification) tags placed on the parts.

Furthermore, in one embodiment, assembly plant 101 includes an RFID reader 107 that scans the RFID tags on the parts in part chambers 401. In one embodiment, scanning RFID tags includes reading, referencing, and/or obtaining electronically stored information from the RFID tags as would be known by one of ordinary skill in the art in light of the present disclosure. In another embodiment, each RFID tag includes an RF transmitter and receiver. In another embodiment, RFID reader 107 transmits a signal which is received by the RFID tag. The RFID tag responds to the RFID reader 107 with information stored in the RFID tag. Such information may include a location of the part with the attached RFID tag. For example, RFID tags (e.g., Air Finder® active RFID tags and the like) may calculate their location relative to reference points and send this data to nearby RFID readers 107. RFID readers 107 may then send such location data to an application (e.g., Air Finder® & Device Tracker application and the like) of server 105 or assembling system 102 via network 103, which formulates an estimated location of the tagged part. In this manner, the current quantity of the parts stored in part chamber 401 may be known. In one embodiment, such a current quantity of the parts stored in part chamber 401 is stored in a storage device of server 105 and relayed to assembling system 102 via network 103 to be stored in a storage device (e.g., storage device 711, 715) of assembling system 102 or directly stored in the storage device (e.g., storage device 711, 715) of assembling system 102 after being provided with such information from RFID readers 107.

If part chamber 401 does not contain a quantity of a designated part (e.g., circuit board of type A) that is below a threshold value, then programming engine 304 continues to determine whether part chamber 401 contains a quantity of a designated part (e.g., circuit board of type A) that is below a threshold value in operation 901.

If, however, part chamber 401 contains a quantity of a designated part (e.g., circuit board of type A) that is below the threshold value (i.e., the current quantity of the part stored in part chamber 401 is below the threshold value), then, in operation 902, programming engine 304 of assembling system 102 instructs a mobile assembling unit(s) 104 either directly or indirectly via server 105 to refill part chamber 401 with additional units of the designated part (e.g., circuit board of type A).

As stated above, when the current quantity of the part stored in part chamber 401 is below a threshold value, which may be user-designated, programming engine 304 instructs a mobile assembling unit(s) 104 to refill part chambers 401 with additional units of the designated part. In one embodiment, such threshold values as well as the maximum quantity of a designated part to be stored in part chamber 401 are stored in a data structure (e.g., table) which resides within the storage device (e.g., storage device 711, 715) of assembling system 102. In one embodiment, such a data structure is populated by an expert.

In one embodiment, programming engine 304 utilizes various software tools for implementing the programming discussed herein, which can include, but are not limited to, Fulcrum®, NetSuite®, MasterControl® MES, Katana Cloud Manufacturing, Arena PLM®, FactoryLogix® MES, etc.

In this manner, different products or the same product with different specifications are effectively assembled in an assembly plant.

Furthermore, the principles of the present disclosure improve the technology or technical field involving assembly plants.

As discussed above, assembly lines are common methods of assembling complex items, such as automobiles and other transportation equipment, household appliances, and electronic goods. Assembly lines are designed for the sequential organization of workers, tools or machines, and parts. The motion of workers is minimized to the extent possible. All parts or assemblies are handled either by conveyors or motorized vehicles, such as forklifts, or gravity, with no manual trucking. Heavy lifting is done by machines, such as overhead cranes or forklifts. Each worker typically performs one simple operation unless job rotation strategies are applied. Robotic systems, referred to as assembly line robots, may also be used to assemble parts, including small intricate parts, on the assembly line. Assembly line robot processes provide the speed and precision manufacturers require without sacrificing quality and accuracy. The flexibility of assembly line robots allows manufacturers to optimize workflow and increase capacity. Currently, assembly lines in assembly plants are used for individual product assembling. For example, a single type of product is assembled on the assembly line of the assembly plant, such as by using assembly line robots. Unfortunately, such an assembly process does not allow the assembling of different products on the assembly line of the assembly plant. For example, different products are not able to be assembled on the same assembly line of the assembly plant by the assembly line robots. Furthermore, such an assembly process does not allow the assembling of a product with various customizations. For example, a product with different specifications is not able to be assembled on the same assembly line of the assembly plant by the assembly line robots. As a result, there is not currently an effective means for assembling different products or the same product with different specifications in an assembly plant.

Embodiments of the present disclosure improve such technology by generating an assembling sequence to assemble one or more products using the mobile assembling units. An “assembling sequence,” as used herein, refers to the order of operations performed by the mobile assembling units, including the paths traveled in the assembly plant to selectively pick designated parts (e.g., brake pads, brake rotors, brake shoes, wheel cylinders, wheel bearings, wheel studs, etc.) from designated part chambers of an array of part chambers. In one embodiment, such an assembling sequence specifies not only the path to obtain such parts, but also specifies the specific parts to be picked from the specified part chamber, the assembling of such parts, including which mobile assembling units are to perform such assembling, etc. Furthermore, in one embodiment, the array of part chambers forms the assembling floor of the assembly plant. Additionally, the mobile assembling units are programmed to move over the array of part chambers in a particular path to selectively pick designated parts from designated part chambers based on the assembling sequence. In this manner, different products or the same product with different specifications may be effectively assembled in an assembly plant using mobile assembling units. Furthermore, in this manner, there is an improvement in the technical field involving assembly plants.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for assembling products using mobile assembling units, the method comprising:
generating an assembling sequence to assemble one or more products using the mobile assembling units, wherein the assembling sequence comprises an order of operations performed by the mobile assembling units to pick designated parts from designated part chambers in an array of part chambers, wherein the array of part chambers forms an assembling floor; and
programming the mobile assembling units to move over the array of part chambers in a particular path to selectively pick the designated parts from the designated part chambers of the array of part chambers based on the assembling sequence.

2. The method as recited in claim 1 further comprising:
programming one or more mobile assembling units of the mobile assembling units to assemble two or more parts forming a final product or a component of the final product using the selectively picked designated parts by the mobile assembling units.

3. The method as recited in claim 1 further comprising:
identifying types of products to be assembled and a number of products with different specifications to be assembled;
identifying how part chambers in the array of part chambers are to be filled based on the identified types of products to be assembled and the number of products with different specifications to be assembled; and
generating the assembling sequence based on the identified types of products to be assembled, the number of products with different specifications to be assembled, and how the part chambers in the array of part chambers are to be filled.

4. The method as recited in claim 1, wherein each part chamber in the array of part chambers is assigned to store a designated part, wherein each part chamber in the array of part chambers is assigned to store a designated number of the designated part.

5. The method as recited in claim 4 further comprising:
identifying when a part chamber in the array of part chambers contains a quantity of the designated part that is below a threshold value; and
instructing a mobile assembling unit of the mobile assembling units to refill the part chamber with additional units of the designated part in response to the quantity of the designated part contained in the part chamber being below the threshold value.

6. The method as recited in claim 1, wherein each mobile assembling unit of the mobile assembling units contains one or more robotic arms configured to pick one or more parts from a part chamber in the array of part chambers.

7. The method as recited in claim 1, wherein part chambers adjacent to each other in the array of part chambers form a rail for movement of the mobile assembling units.

8. The method as recited in claim 1, wherein the array of part chambers is configured in a three-dimensional manner.

9. A computer program product for assembling products using mobile assembling units, the computer program product comprising one or more computer readable storage mediums having program code embodied therewith, the program code comprising programming instructions for:
generating an assembling sequence to assemble one or more products using the mobile assembling units, wherein the assembling sequence comprises an order of operations performed by the mobile assembling units to pick designated parts from designated part chambers in an array of part chambers, wherein the array of part chambers forms an assembling floor; and
programming the mobile assembling units to move over the array of part chambers in a particular path to selectively pick the designated parts from the designated part chambers of the array of part chambers based on the assembling sequence.

10. The computer program product as recited in claim 9, wherein the program code further comprises the programming instructions for:
programming one or more mobile assembling units of the mobile assembling units to assemble two or more parts forming a final product or a component of the final product using the selectively picked designated parts by the mobile assembling units.

11. The computer program product as recited in claim 9, wherein the program code further comprises the programming instructions for:
identifying types of products to be assembled and a number of products with different specifications to be assembled;
identifying how part chambers in the array of part chambers are to be filled based on the identified types of products to be assembled and the number of products with different specifications to be assembled; and
generating the assembling sequence based on the identified types of products to be assembled, the number of products with different specifications to be assembled, and how the part chambers in the array of part chambers are to be filled.

12. The computer program product as recited in claim 9, wherein each part chamber in the array of part chambers is assigned to store a designated part, wherein each part chamber in the array of part chambers is assigned to store a designated number of the designated part.

13. The computer program product as recited in claim 12, wherein the program code further comprises the programming instructions for:
identifying when a part chamber in the array of part chambers contains a quantity of the designated part that is below a threshold value; and
instructing a mobile assembling unit of the mobile assembling units to refill the part chamber with additional units of the designated part in response to the quantity of the designated part contained in the part chamber being below the threshold value.

14. The computer program product as recited in claim 9, wherein each mobile assembling unit of the mobile assembling units contains one or more robotic arms configured to pick one or more parts from a part chamber in the array of part chambers.

15. The computer program product as recited in claim 9, wherein part chambers adjacent to each other in the array of part chambers form a rail for movement of the mobile assembling units.

16. The computer program product as recited in claim 9, wherein the array of part chambers is configured in a three-dimensional manner.

17. A system, comprising:
a memory for storing a computer program for assembling products using mobile assembling units; and
a processor connected to the memory, wherein the processor is configured to execute program instructions of the computer program comprising:
generating an assembling sequence to assemble one or more products using the mobile assembling units, wherein the assembling sequence comprises an order of operations performed by the mobile assembling units to pick designated parts from designated part chambers in an array of part chambers, wherein the array of part chambers forms an assembling floor; and
programming the mobile assembling units to move over the array of part chambers in a particular path to selectively pick the designated parts from the designated part chambers of the array of part chambers based on the assembling sequence.

18. The system as recited in claim 17, wherein the program instructions of the computer program further comprise:
programming one or more mobile assembling units of the mobile assembling units to assemble two or more parts forming a final product or a component of the final product using the selectively picked designated parts by the mobile assembling units.

19. The system as recited in claim 17, wherein the program instructions of the computer program further comprise:
identifying types of products to be assembled and a number of products with different specifications to be assembled;
identifying how part chambers in the array of part chambers are to be filled based on the identified types of products to be assembled and the number of products with different specifications to be assembled; and
generating the assembling sequence based on the identified types of products to be assembled, the number of products with different specifications to be assembled, and how the part chambers in the array of part chambers are to be filled.

20. The system as recited in claim 17, wherein each part chamber in the array of part chambers is assigned to store a designated part, wherein each part chamber in the array of part chambers is assigned to store a designated number of the designated part.
